(19) United States
(12) Patent Application Publication
(10) Pub. No.: US 2009/0230364 A1
(43) Pub. Date: Sep. 17, 2009

(54) CRYSTALLINE METALLIC NANOPARTICLES AND COLLOIDS THEREOF

(75) Inventors: Maciej J. PIKE-BIEGUNSKI, Serock (PL); Pawel BIEGUNSKI, Naperville, IL (US)

Correspondence Address: Momkus McCluskey, LLC, 1001 Warrenville Road, Suite 500, Lisle, IL, 60532, US

(73) Assignee: Nano Technologies Group, Inc., Naperville, IL (US)

(21) Appl. No.: 12/411,170

(22) Filed: Mar. 25, 2009

Related U.S. Application Data
(63) Continuation-in-part of application No. 12/442,050, filed on Mar. 19, 2009.

(30) Foreign Application Priority Data
Sep. 21, 2006 (PL) P.380649

(51) Int. Cl. H01B 1/22; B22F 9/14; B32B 15/02; B23H 1/00

(52) U.S. Cl. 252/514; 75/345; 428/402; 219/69.18; 252/500

(57) ABSTRACT

Apparatus for forming metallic crystalline nanoparticles includes a dispersion medium, first and second electrodes separated from each other by a predetermined span and being inserted into the dispersion medium. The electrodes are connected to a supply of electrical current at a preselected voltage. A filament is in contact with the two electrodes and is also inserted into the dispersion medium. Upon a first switch connecting the supply of electrical current to the electrodes, a pulsed current passes through the electrodes and the filament at a voltage preselected to disintegrate the filament into fragments, but does not create plasma from the filament. The fragments include a plurality of crystalline nanoparticles

### RELATED APPLICATIONS

This application is a filed continuation in part application of application PCT/PL 2007/000067, filed 20 Sep. 2007 and published 27 Mar. 2008, which claims priority to Polish national application P.380649 filed 21 Sep. 2006, the specification and drawings of which are fully incorporated by reference herein.

### BACKGROUND OF THE INVENTION

The present invention relates to the shape, composition, structure and characteristic properties of crystalline nanoparticles (nanocrystallites) as well as a method of producing the crystalline nanoparticles (nanocrystallites). The nanoparticles may be used in colloids and may be manufactured using a non-explosive, electrical method of degrading such as metals or their alloys.

The phenomenon of the explosive disintegration of wire has been known since Faraday's time. As early as in the XIX century, it was noted that a high-density current causes the violent disintegration of a conductor or a filament. Thus, at a comparatively early stage of electrical and material studies during the XIX century, the melting (softening) currents of metals were determined. Under the influence of high-amperage direct currents, most metals undergo rapid softening when the internal, electrical charge potential reaches about 0.5 volts per centimeter of length of the filament.

In the case of silver, a charge of merely 0.5 volts/cm causes the electrical current to reach a charge density of about 300,000 ampheres/cm², causing the filament to soften and melt. Such rapid melting of metals initially occurs at the junction of two differing conductors because it is at the point of contact that the most heat is produced. This phenomenon has found many applications in the field of welding, particularly contact welding or resistance welding.

As the current density increases, the heat produced may go beyond merely softening or even melting the metal, causing electroexplosive fragmentation as critical current densities are reached. Earlier published Polish Patent Application Nos. 365,435 A1, 371,355 A1, and 328,182 A1 describe methods of obtaining metallic colloids through the use of an electric pulse through a wire, resulting in an electroexplosive fragmentation of the wire.

Unfortunately, the explosive method of creating nanoparticles has several drawbacks, including oxidation of the nanoparticles, formation of spheroids, and difficulty in controlling the temperature within the explosion zone. By better controlling the amount and duration of the current, the inventors have developed a non-explosive method of creating metallic nanoparticles that is superior to the explosive method because of the particles' unique physical properties such as size and shape as well as the controllability of the process conditions.

### BRIEF SUMMARY OF THE INVENTION

Apparatus for forming crystalline nanoparticles include a dispersion medium, first and second electrodes spaced from each other by a predetermined span. The electrodes are at least partially surrounded by or inserted into the dispersion medium and are preferably made of a metal, such as copper, stainless steel, tungsten, or titanium. The apparatus further includes a filament at least partially surrounded by or inserted into the dispersion medium and being in contact with the first and second electrodes. Preferably, the filament is in the form of a wire and has a length at least as great as the span. The apparatus includes circuitry selectively coupled to the first and second electrodes by a first switch for supplying a pulse of current at a preselected voltage. Upon the first switch connecting the circuitry to the electrodes, a pulsed current passes from the first electrode through the filament to the second electrode wherein the voltage is preselected to be high enough to disintegrate the filament into fragments that include a plurality of crystalline nanoparticles but is low enough to avoid creating plasma from the filament.

A method for forming crystalline nanoparticles comprises connecting a conductive filament from a first electrode in a dispersion medium to a second electrode in the dispersion medium and spaced from the first electrode, such that the filament, in a predetermined span between the first and second electrodes, is in contact with the dispersion medium. The method further comprises pulsing a current at a predetermined voltage through the filament from the first electrode to the second electrode and, responsive the pulsing, disintegrating the filament into a plurality of fragments that include crystalline nanoparticles. The predetermined voltage of the pulsed current is selected that the step of disintegrating is not accompanied by the formation of plasma from the filament.

A plurality of crystalline nanoparticles comprise an electrically conducting material in the form of platelets having an average diameter between approximately 2-10 nanometers and having an average thickness of between approximately 2-10 atomic layers. Preferably, the nanoparticles have a homogenous metallic structure lacking chemical impurities and crystalline defects. More preferably, the electrically conducting substance is selected from a group containing chemically pure metals, metals contaminated (on purpose) with additives, alloys or solid-state mixtures of metals, alloys of metals, and semiconductors.

A colloid comprises a dispersion medium and a dispersed phase comprising non-ionic nanoparticles of an electrically conducting substance in the form of platelets and having an average diameter between approximately 2-10 nanometers and an average thickness between approximately 2-10 atomic layers.

### BRIEF DESCRIPTION OF THE DRAWINGS

To better illustrate the nature of the present invention, the description has been supplemented with the following figures:

FIG. 1 is an isometric view of an apparatus for forming crystalline nanoparticles;

FIG. 2 is a schematic showing a circuit for controlling and modifying electrical current to the apparatus of FIG. 1.

FIG. 3 is a flow diagram showing a method of forming crystalline nanoparticles.

FIGS. 4A, 4B, and 4C are photographs which show SEM (Scanning Electron Microscope, 50,000× magnification) images of metal fragments produced using explosive metal disintegration. Spheroids with diameters of about 200 nm and about 50 nm are visible.

FIG. 5 shows a photographic image of a reactor in which explosive disintegration of a wire was performed. A plasma region is visible in the photograph.

FIG. 6 presents an oscilloscope readout (oscillograph) of the capacitor current charging the circuit in which the explosive disintegration of wire occurs. Current amperage as a function of time is independent of the RLC value in the circuit. The oscillogram presents a “spike surge” which occurs very briefly in conjunction with the time constant of the LC circuit. Note from the oscillogram that the explosion lasts for less than 0.5 microseconds.

FIG. 7 presents an oscillogram of a capacitor current discharged via a jumper. The capacitor current amperage is dependent on RLC circuit constants. This oscillogram shows the graph of a current alternating sinusoidal with an exponentially decreasing amplitude. The oscillation frequency is the known function of induction (L) and circuit capacity (C) and has an oscillation period of about 4 microseconds.

FIGS. 8A-C present Transmission Electron Microscopy (TEM) images of metal fragments produced via non-explosive disintegration of wire. The silver platelets are so thin, that the graphite substrate of the carbon substrate membrane is “visible” through them.

FIGS. 9A and 9B present the non-explosive disintegration of wire in a water reactor. The image is an analog photographic record from a reactor in which non-explosive disintegration of wire was taking place. Note that no plasma is visible in the photograph, but tracks formed by metal fragments ejected from the wire are visible. A characteristic brush pattern occurs. Bubbles of water vapour and gases dissolved in water (oxygen, nitrogen) are also visible, resulting from an ultrasonic cavitation effect.

FIG. 10 is an oscillogram of a current in connection with the non-explosive disintegration of wire. In contrast to the oscillogram from FIG. 6, the current in this case is a square root of the RLC values of the circuit. The point at which the current is lost (shown on the time axis) corresponds to the time of disintegration. The oscillograph of the non-explosive disintegration shows that the duration of the event is about 4-5 microseconds (compare to the explosion method above, less than 0.5 microseconds in FIG. 6).

FIG. 11 is a histogram showing the average particle size distribution of the metallic nanocrystallites.

FIG. 12 is an electron diffraction pattern recorded for two different silver species: a) the nanometer in size particle, b) the micrometer in size particle.

### DETAILED DESCRIPTION

The subject of the invention is a method of producing a colloid or its derivative, characterized in that the filament is placed in a dispersion medium, subjected to electrical disintegration by a controlled current from a charged electrical capacitor, wherein the process of electrical disintegration is non-explosive and the temperature of disintegration of the filament is lower than its melting temperature, and the electrically conducting substance forms a dispersed phase of a colloid.

Due to their unique properties, nanoparticles according to the present invention can find numerous applications the manufacture of preparations for decontamination, disinfection, prophylaxis or treatment, and for use in one or more of the following disciplines: dermatology, eye medicine, laryngology, urology, gynaecology, rheumatology, oncology, surgery, veterinary medicine, dentistry, halitosis, plant protection, food technology, conservation and disinfection of food preparation and storage equipment, etc. Additionally, the nanoparticles are particularly useful in the manufacture of preparations for purifying water, non-antibiotic growth stimulants, the internal and external antibacterial, antiviral and antifungal protection of eggs (particularly chicken eggs) against various bacterial infections such as Salmonella, Escherichia, (e.g. E. coli), Pseudomonas, Staphylococcus (e.g. S. aureus) and Streptococcus antibacterial, antiviral and antifungal protection of animal farms antibacterial, antiviral and antifungal protection and/or production of textiles, clothing, footwear, synthetic and natural materials, construction materials, paints and varnishes, wound dressings, dietary supplements, nutrient supplements, washing and ironing preparations, chewing gum, sweets, food, cosmetics, toothpaste, mouthwash, dressings, sticking plasters, gel dressings, gels, hygienic pads and tampons, gauze, cotton, diapers, bandages, feed supplements, water additives, beverage additives, beverages, medical and veterinary preparations, immunostimulatory preparations, energy drinks, gels and pastes, and in the manufacturing of polymer or cellulose antibacterial foils and antibacterial packaging and containers.

Additionally, the nanoparticles may be use in the manufacturing of electronic materials including electrically-conducting glues, inks for printing electrical circuits, elements of passive electrical circuits or greases for electrical contacts, superconductors, in the manufacture of photographic films, photosensitive materials and photosensitive arrays (e.g. LCD-type), protective preparations for plants, antibacterial, antiviral and antifungal protection of public spaces and the production of paints, varnishes and coatings which reflect or absorb electromagnetic radiation, particularly microwaves. Additionally, the nanoparticles may be used in the manufacture of cosmetic and personal care preparations, rejuvenating preparations, anti-inflammatory and anti-rheumatoid preparations, orally administered preparations including those meant for ingestion and those meant for oral rinsing, preparations in the form of liquids, lotions and gels and solid preparations, injectable preparations, pharmaceutical agents, household chemicals, industrial chemicals, agricultural agents and veterinary agents. Preferably, pharmaceutical agents are manufactured using a colloid containing a precious metal, especially silver, copper or gold or an alloy of the above metals with an addition of at least one substance selected from among gold, palladium, platinides, copper and other nonprecious metals. The pharmaceutical agent produced may be a preparation selected from among: antibiotics, antifungals, antivirals, anti-tumour preparations, and preferentially selected from among disinfectants, decontaminants, prophylactics or treatments. The preparation produced may be in the form of an aqueous suspension containing nanoparticles of silver, its alloys or other metals.

In addition, the nanoparticles according to or a colloid according to the invention, as defined above, are useful in the production of paints, varnishes, fillers, putty, and other coatings or fillers with the following properties: antibacterial, antifungal, antimold, antiviral and antielectrostatic, or ones absorbing electromagnetic or ionizing radiation. Preferably, a colloid or its derivative contains a metal in order to be an efficient electrical filament, preferentially copper and its alloys. Further, they may be used in the manufacture of fuels, lubricants, enhancing additives thereof or catalysts for the enhancement and purification in fuel combustion of hydrocarbons or rocket propellant.

Further, the nanoparticles may be used in the manufacturing of preparations for aiding healing, such as in the manufacture of antibacterial, antiviral and antifungal preparations or ones possessing combined properties, e.g. antibacterial-antifungal, antibacterial-antiviral, antibacterial-antifungal-antiviral, preparations for use in veterinary medicine, animal care and rearing, filters, including cigarette filters, antistatic preparations and materials, photovoltaic and electrovoltaic cells, batteries and accumulating batteries, preparations containing an electrically conductive material or its alloy, which may contain other additives in the form of nanoparticles, antibacterial and antifungal applications, medicine, sanitization, disinfection, bactericides or fungicides, antibacterial and antifungal prophylaxis, plant protection, domestic animal protection, cosmetics, wound dressings, antibacterial wound dressings, medical and cosmetic gels, wound dressing and regenerative gels (i.e. for burns), safety and conservation of food products, in particular easily spoiled goods such as eggs and their derivatives, ice-cream, mayonnaise, cheese, fish, seafood, meat (in particular ground meat) fruits and vegetables, water and beverage additives, diet supplements, cosmetics (creams, gels, lotions, tonics, pastes, liquids and soaps, as well as household products).

Finally, the nanoparticles may be used for additives for laundry and ironing, washing up, washing, protection of textiles, conservation of footwear, disinfection of spaces and surfaces, disinfection and protection of agricultural enterprises including animal inventory, protection of the body and feet, protection of plants, in particular fruit, vegetables and flowers, nanobiotics, disinfection, and purification of water; in the manufacturing of immunostimulants, food supplements, fuel additives for increasing their energy yield and shelf-life, fuel additives for decreasing the pollutants produced during combustion, lubricant additives for improving their mechanical properties, antiviral agents. Additionally, the nanoparticles may be applied as “enhancers” for improving material the properties of various materials (those substances to which they are added) and used in the manufacture of anti-bacterial foils, in the treatment of bacterial, fungal and viral infections, electrically conductive substances such as paints, varnishes, foils and coatings, antistatics in polymers such as nylon, polymer, fibrous materials for use in textiles, and in the production of antistatic fibres.

### Longitudinal Forces and the Explosive Disintegration of Wires:

It has been shown that longitudinal forces occur in every filament in which an electrical current flows. Such forces are strictly quantum mechanical in character. The source of the longitudinal forces in metallic filaments is explained by the collisions of electrons with structural metal crystal defects, impurities, and the crystalline lattice (phonons).

When metallic conductors are subjected to high-density currents, the force that results from electrons colliding with metal ions exceeds the cohesive forces of the metal, causing it to break up into fragments. During disintegration, the metal forms an immense number of microscopic metallic fragments.

High electric current densities through an uncooled metal delineate the lower electrical boundary of metal stability under normal conditions. However, an upper bound under nearly ideal conditions may be established through external cooling of the metal. Since large amounts of heat are removed, metals that are rapidly cooled by air, water, liquid nitrogen, etc., may have much larger current densities than those found in technical literature. The inventors' experiments have shown, however, that with even the most efficient metal cooling, current density may not be infinitely increased. Even under nearly ideal conditions, such as immersion in liquid nitrogen, critical current loads may cause metal disintegration.

In the inventors' experiments, a thin silver foil was cooled with a stream of liquid helium. It was observed that despite such effective cooling, short electrical impulses of high-density current still caused explosive disintegration. Thus, it is possible to empirically determine the upper bounds of metal stability for each metal and determine a critical level of current density. After this upper boundary is exceeded, the metal explodes.

In practice, however, we rarely use metals immersed in cryogenic substances such as liquid N₂ or liquid He₂. Electrically stimulated metal disintegration processes in water or organic liquids are more typical, since they are technologically successful, less costly, and have found practical applications in the production of colloidal materials or nanoparticle preparations.

The conditions and techniques by which such the disintegration takes place in a liquid medium is of particular practical importance. Metallic fragments formed as a result of non-explosive disintegration may reach nanoparticle sizes and can be characterized by a very large surface area. In numerous experiments, the inventors have produced nanoparticles originating from precious and nonprecious metals and alloys and subjected the resulting particles to structural and biocidal testing.

### Explosive Production of Nanoparticles

The explosive disintegration of wire facilitates a relatively simple means of producing metallic nanoparticle materials. However, this process has a number of considerable, negative consequences that stem from both the numerous undesirable properties of the nanoparticles themselves, as well as process safety concerns. For example:

1. it is impossible to control temperature within the explosion zone and the filament itself, since plasma is formed in the explosion channel;

2. as a result of plasma activity, the metal fragments ejected from the filament melt, whereafter the metal fragments cool rapidly;

3. the melted fragments rapidly solidify in the liquid, forming spheroids;

4. spheroids have the smallest possible active surface area;

5. plasma causes oxidation, significantly degrading the crystal structure of the nanoparticles and introducing impurities; and

6. the appearance of plasma, in conjunction with the disintegration and melting of the metal, causes explosions that result in high energy wave phenomena and equipment damage.

A typical wire explosion occurs in a small volume over a very short time but considerable energy may be released. For example, a wire that is 1 mm in diameter and 10 cm in length occupies a volume of 0.1 cm³. The explosion volume, however, is about 10 cm³, or one hundred times the original volume.

In terms of the energy released, the energy of the discharged 1 μF capacitor at 5,000 volts is 12.5 Joules, but usually lasts a fraction of a microsecond. Thus, the explosion may reach an energy level of many megawatts and result in a very large explosive detonation wave, which can destroy instrumentation and equipment.

Further, to be economically viable and effective, industrial production of nanoparticles through the explosive process requires an explosion every 1 to 10 seconds. As production is carried out over the course of days, weeks, and months, the large number of repeated explosions may lead to the catastrophic destruction of manufacturing equipment and possibly even bodily injury of workers.

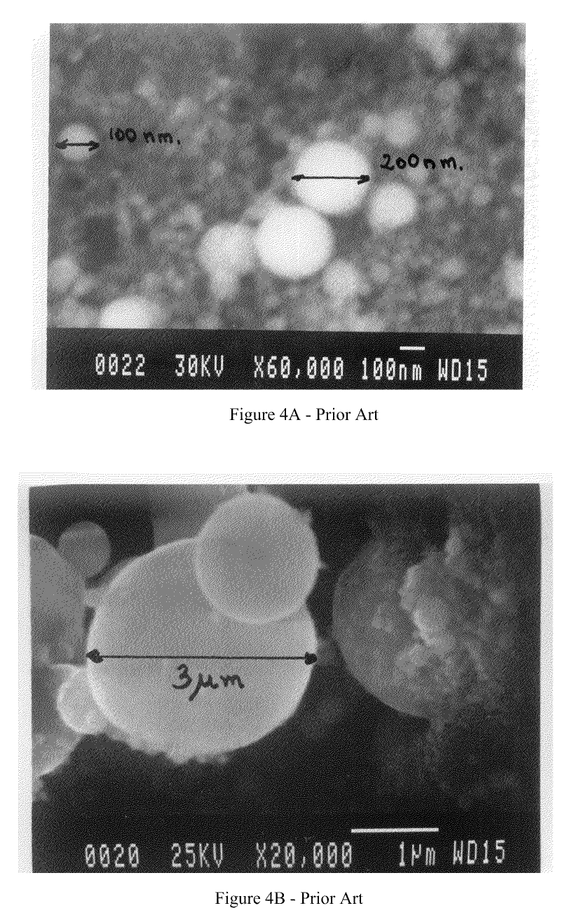

It is worthy of mention that the explosive processes of making nanoparticles uses only a small fraction of the energy originating from the current source. A great surplus of energy is wasted since it is released into the wire-containing liquid forming, plasma and heat. The intense heat melts the metal and, upon cooling, the molten metal forms spherical metal particles. As discussed above, the active surface area of these spherical particles is greatly reduced and they often exhibit unpredictable atomic structures. Fragments of this type are illustrated in FIG. 4A-C.

Another undesirable side effect of such a production process is the appearance of plasma. When plasma contacts a liquid medium such as water, it causes a detonation, producing waves with considerable energy. As discussed above, the detonation wave exerts a considerable, highly negative effect on the structure and shape of the nanoparticles produced as well as the process equipment.

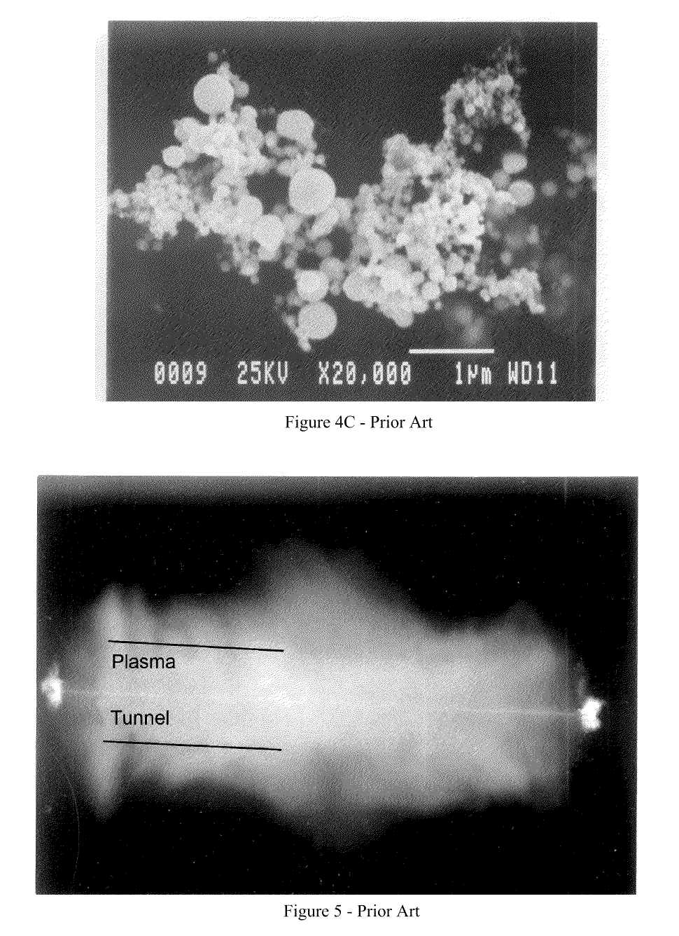

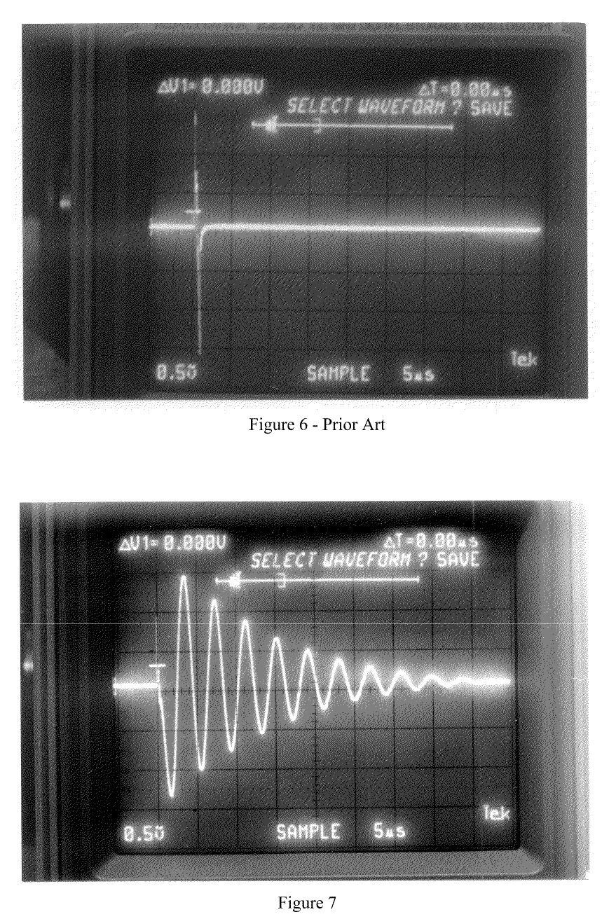

FIG. 6 shows an oscillogram of the current accompanying the wire explosion. It shows a “spike event” characterized by a large electrical current flowing through a wire in an extremely short time. The plasma channel is visible in FIG. 5. As stated before, the force of such a current event released into the plasma channel is immense and can amount to many megawatts. For comparison, FIG. 7 shows an oscillatory current graph of a diminishing amplitude. This oscillogram was recorded for the capacitor discharge into a so-called “jumper” load.

non-explosive particle production

In contrast to the explosive production process, a non-explosive process would provide numerous benefits in terms of both process control and quality of the nanoparticles. The present invention facilitates a radical technology improvement and differs significantly from the explosive process. This improvement is due largely to a decreased energy profile over a longer period of time. In accordance with the present invention, electrical energy is released only into the interior of the metal, resulting in flat fragments in the form of platelets or flakes with a face centered cubic (FCC) crystalline structure. The overall current density is lower than in the explosive method, but is sustained for a longer period of time, resulting in a lower wire temperature. Since the temperature of the wire is lower, no plasma is formed, the wire does not melt, the particles do not form spheres, and no detonation occurs.

The amount of energy required to disintegrate the filament varies by type of material used in the filament, by the length of the filament, and other parameters such as purity of the filament and charging circuit parameters, but are generally determined by the equation:

E=½CV²;

where C is the capacitance and V is the voltage. Generally, the energy applied to the filament by pulsed current is between approximately 15 watt seconds/mm³ and approximately 100 watt seconds/mm³, preferably between approximately 20 watt seconds/mm³ and approximately 41 watt seconds/mm³.

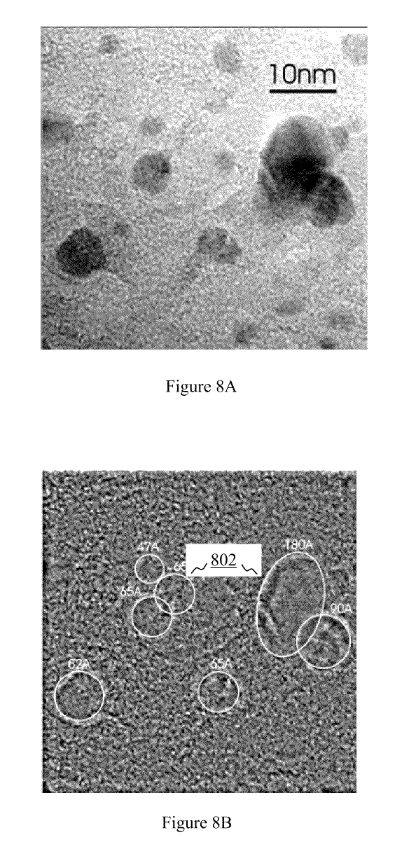

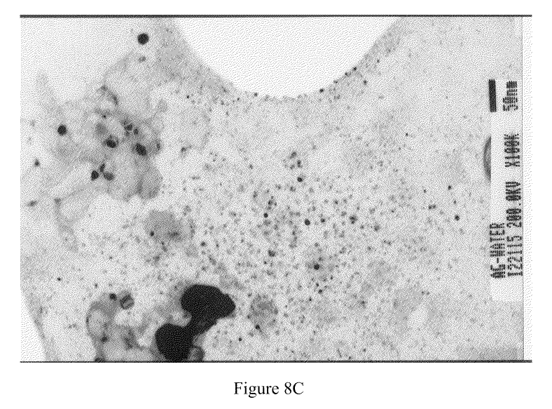

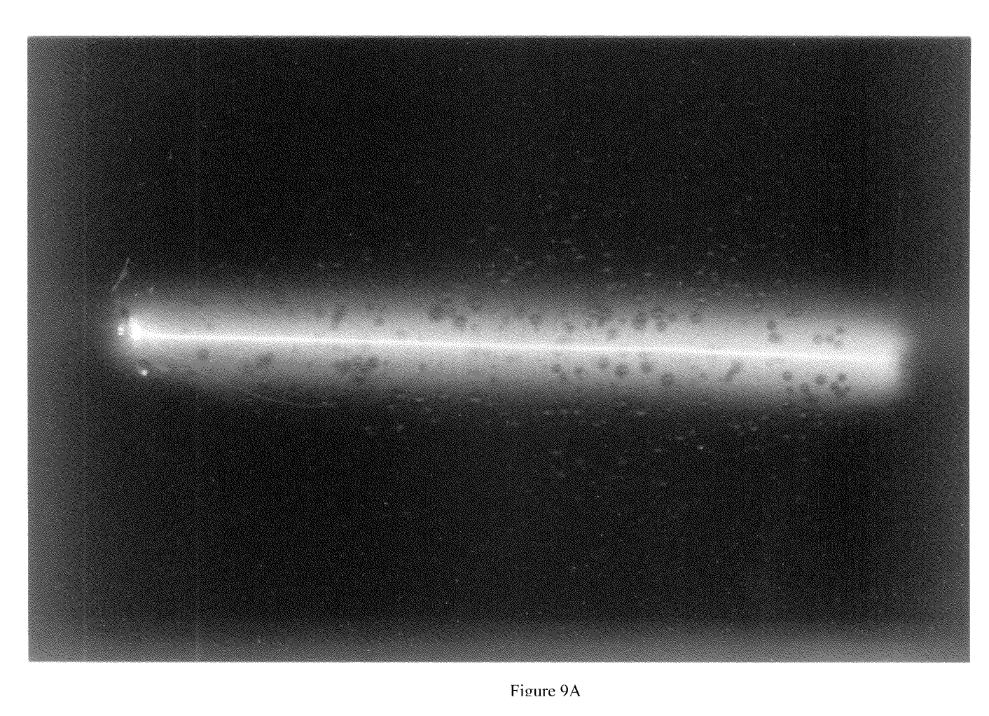

FIGS. 8A-C present TEM images of silver fragments formed non-explosively. These images show small, flat metallic structures only several atoms thick, which are nearly transparent to the electrons in the electron transmission microscope. The silver atoms are arranged in parallel rows (FCC crystalline structure). The diameter of such a nanoparticle is on average only a few nanometers. The active surface area of the preparations according to the technology described here is over 100 m²/g (square meters per gram of metal used).

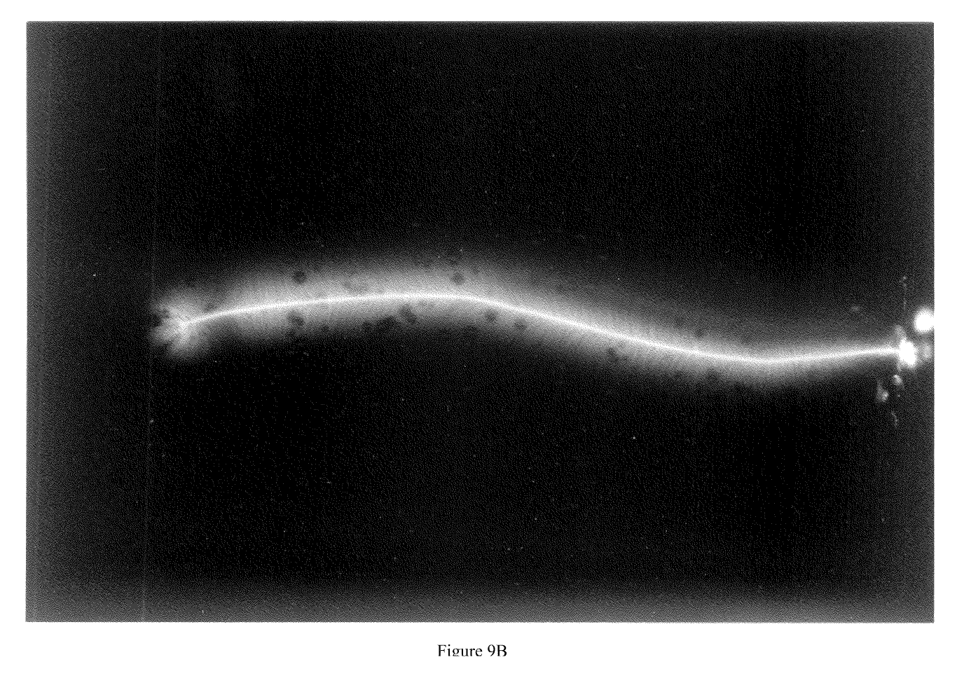

FIGS. 9A and 9B are photographs showing the disintegration of wire in the reactor. The wire is visibly forming metallic fragments forming a characteristic brush image.

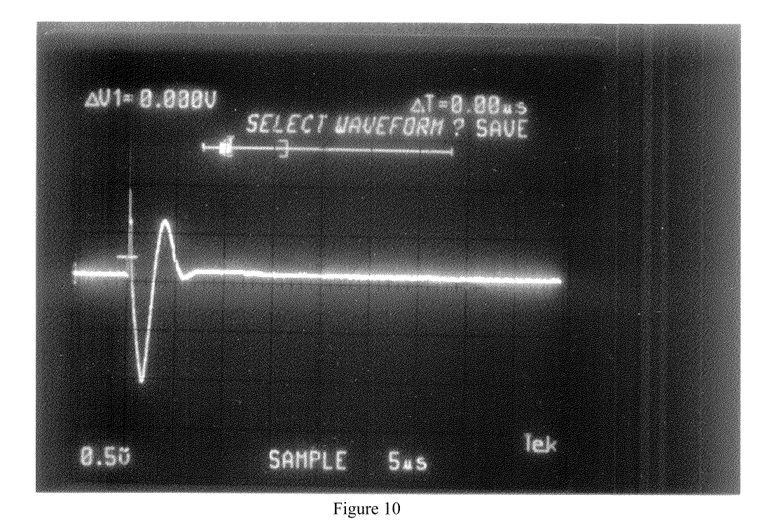

FIG. 10 shows an oscillogram of the non-explosive disintegration. We see that this oscillogram represents only a curved section of the natural discharge of a capacitor through a jumper, in contrast to the oscillogram shown previously in FIG. 7. As can be seen, during the non-explosive disintegration of the wire, the capacitor discharge current exhibits only the initial oscillation fragment shown in FIG. 7. This is explained by the fact that in the case of a thin wire, during the first oscillation, the filament is fragmented and the circuit is broken and the electricity ceases to flow. Since plasma does not form, no further oscillations to be sustained through the plasma channel. The x-axis (time) of FIG. 10 shows that the wire disintegration process is finished at the point where the graph breaks off. This duration of such a novel, non-explosive process lasts typically about several microseconds.

As a result, a radical improvement in the product quality is achieved. In particular, the desirable biocidal properties of the particles are greatly improved because they are related to both the atomic structure of the formed particles and with the active surfaces. TEM studies in this case show nanoparticles exhibiting an FCC cubic structure. These particles are in the form of flakes barely several atoms thick, resulting an immense active surface area.

Preferentially, the electrical energy delivered to the wire has been significantly reduced. Whereas explosive disintegrations have energies in the range of several dozen to thousands of joules, the present invention only uses from a fraction of a joule to several joules of energy.

The duration of the current in the explosive method is limited to a fraction of a microsecond and is independent of the RLC circuit parameters. Also, the temperature of the wire greatly exceeds the melting temperature of the metal.

In contrast, the disintegration time in the non-explosive method is longer, typically lasting from several microseconds to several dozen microseconds. The duration of the non-explosive disintegration is a function of the electrical parameters of the RLC circuit and the wire temperature is much lower than the melting temperature of metal. Table 1 presents the comparative data of process parameters used in the explosive method and the non-explosive method.

TABLE 1
Comparison of Data Compiled Explosive
and Non-Explosive_Methods

| | Explosive Method | Non-Explosive Method |
|---|---|---|
| Capacitor cap. | 10 microfarads | 0.5 microfarads |
| Potential | 5000 Volts | 20 000 Volts |
| Duration | 0.5 microseconds | 5.0 microseconds |
| Filament length | 1 meter, parallel line | 20 cm. axial line |
| Filament type | symmetrical cable | concentric wire |
| Resistance | unmatched load resistance | matched load resistance |

### Shape, Composition, Structure, and Properties of Crystalline Metallic Nanoparticles

Crystalline nanoparticles, called nanocrystallites, that are produced as a result of the non-explosive, electrical disintegration of metal possess characteristic properties and a unique physical structure. Specifically, the nanocrystallites take the shape of tiny leaves or flakes with regular sides (as in a crystal) and exhibit astounding thinness, on average of several atoms in dimension. Here, we speak specifically of the “flake geometry” of nanocrystallites. The nanocrystallites possess immense active surface areas because they are practically flat structures. The thicknesses of the particles have been reduced to the minimum, on average several atoms, resulting in an extremely high active surface area. For example, the surface area of silver has been measured to be approximately 100 m² per gram. Because of these high surface areas and platelet geometries, the nanocrystallites adhere very easily to most solid surfaces.

In addition, the activity of the particles is further enhanced due to the fact that each platelet forms a mono-crystal and is essentially free of surface contaminants such as oxidants that are found for similar nanoparticle products obtained by chemical or explosive processes.

Further, the nanocrystallites, as described above, are very durable and stable. In the case of silver, they do not react with most chemical compounds, not even with most acids. Royal water (aqua regia) is needed to dissolve them. Nanocrystallites (including silver) are photostable, so they do not react to sunlight and do not undergo chemical reactions.

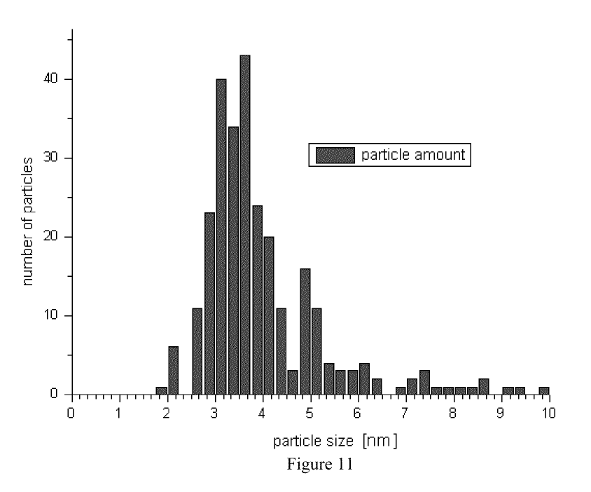

As described above, approximately 80% of the nanocrystallites usually possess a diameter of about 35 Angstroms (see FIG. 11) and a thickness of about 10 angstroms. The non-explosive, electrical disintegration of metals and their alloys results in nanocrystallites of the above diameter, whereas the remaining 20% are larger but have the same thickness. FIGS. 11A-E are TEM images of the flat nanoparticles.

The characteristics of the nanoparticles obtained in this novel method were determined by the Electron Microscopy Laboratory of the Institute of Environmental Radiography and Electron Microscopy Laboratory of the Polish Academy of Sciences in Warsaw according to the method of analysis set forth below.

The preparation for TEM imaging of the nanoparticles consisted of pipetting two drops of the “Nano-Silver 04-21-06” liquid onto a copper grid (3 mm diameter) coated with a perforated carbon membrane (No. S147-4H, Agar Scientific). The estimated volume of one drop was 14 μl (volume of a 1.5 mm sphere).

The studies were performed using a JEM2000EX TEM using a 200 keV electron beam and images were recorded on photographic film which were then scanned on a Super Colorscan 8000 from Nikon. Diffraction images were scanned at 1000 dpi and high-resolution TEM images were scanned at 4000 dpi. The contrast resolution was 14 bits.

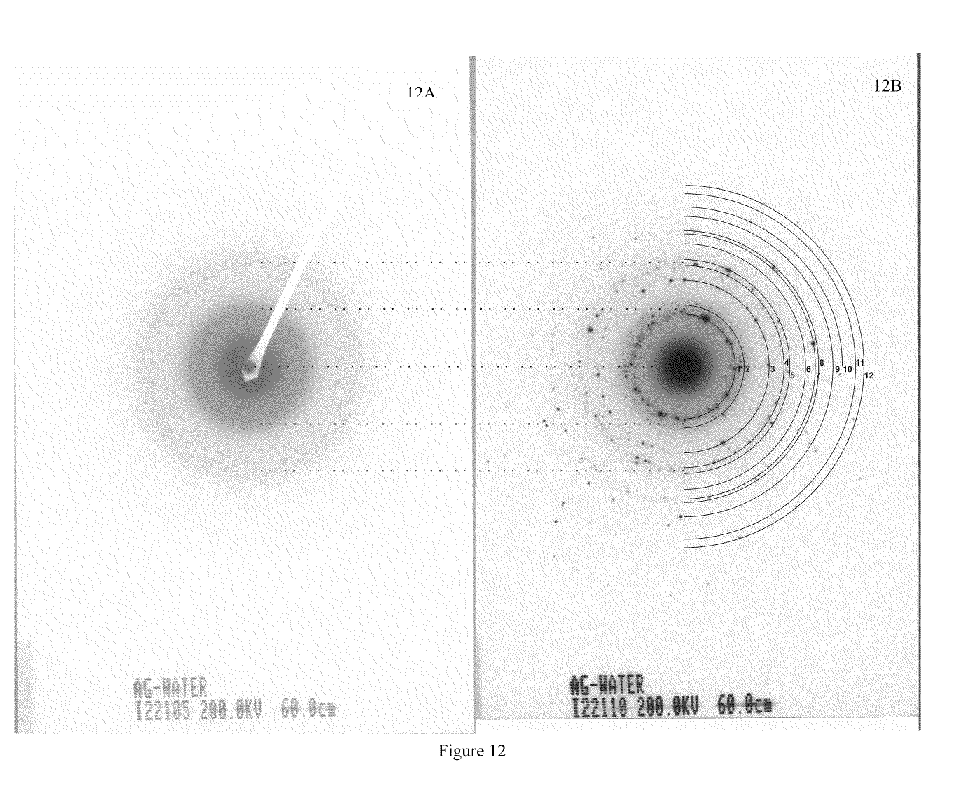

The TEM images showed that crystalline particles settled on the carbon holder, the matrix. There was a clear division of particles in two size ranges, micron-sized particles and nanometer-sized particles. Diffraction images (see FIGS. 12A and 12B) of the micron particles show “point” reflections arranged in concentric rings. The diameters of these rings were measured and compared to standard values corresponding to the structure of crystalline silver.

Table 2 shows data collected from the surface measurements of the nanoparticles. The first column of the table gives the respective ring number beginning with the ring with the least diameter and the second column contains ring diameters empirically derived from the TEM images. The third column contains standard values of atomic spacing between the planes for the FCC crystalline structure of silver (a=4.078 Å), while the fourth column contains the product of the second and third column. The fifth, sixth, and seventh columns contain Miller indices and the last column represents the lattice constant calculated using the equation:

$$a = \frac{\sqrt{{h}^{2} + {k}^{2} + {l}^{2}}}{2 r} D$$

where 2r is ring diameter (value of column 2), h, k, l are Miller indices (columns 5, 6 and 7), and D is the constant of the microscope camera with an average value of column 5.

TABLE 2
Surface Measurement Data

| Lp. | 2r [mm] | d [A] | 2r * d [mm * A] | h | k | l | a [A] |
|---|---|---|---|---|---|---|---|
| 1 | 13.0 | 2.355 | 30.62 | 1 | 1 | 1 | 4.107 |
| 2 | 15.2 | 2.039 | 30.99 | 0 | 0 | 2 | 4.056 |
| 3 | 21.3 | 1.442 | 30.71 | 0 | 2 | 2 | 4.093 |
| 4 | 25.0 | 1.230 | 30.75 | 1 | 1 | 3 | 4.089 |
| 5 | 26.5 | 1.177 | 31.19 | 2 | 2 | 2 | 4.029 |
| 6 | 30.3 | 1.020 | 30.91 | 0 | 0 | 4 | 4.069 |
| 7 | 32.7 | 0.936 | 30.61 | 1 | 3 | 3 | 4.109 |
| 8 | 33.6 | 0.912 | 30.64 | 0 | 2 | 4 | 4.102 |
| 9 | 37.1 | 0.832 | 30.87 | 2 | 2 | 4 | 4.070 |
| 10 | 39.4 | 0.785 | 30.93 | 1 | 1 | 5 | 4.065 |
| 11 | 42.7 | 0.721 | 30.79 | 0 | 4 | 4 | 4.083 |
| 12 | 44.8 | 0.689 | 30.87 | 1 | 3 | 5 | 4.070 |
| | | Average | 30.82 | | | | 4.078 |

| | |
|---|---|
| Std. Deviation | 0.023 |

Based on electron wavelength, the constant D (λ=0.0251 Å) with an energy of 200 keV and a camera length of 60 cm is D=2*600 mm*0.051 A=30.1 mm*Å.

Diffraction images (see FIG. 12b) from areas containing nanoparticles showed two diffuse rings, whose radii correspond to distances between vertices with the Miller indices {111} and {222}. The occurrence of diffuse rings is evidence of the fact that the size of the diffusing objects is less than 10 nanometers. Nanoparticle sizes were examined using TEM images and the dark field technique based on the electrons forming the first diffraction ring. The result was presented on a frequency plot of the occurrence of particles according to size shown in FIG. 11. It was assumed that the particles are spherical. FIG. 8B presents TEM images with overlaid rings, whose diameters were taken to be particle diameters. Particle sizes ranged from 2 to 8 nm, with an average value of 3.5 nm (see histogram, FIG. 11). A 400,000× magnified image (FIG. 8A) shows individual nanoparticles with visible systems of parallel straight lines. The distances between the lines are indicative of type {111} silver. On this basis, it may be stated that the nanoparticles have a defect-free, crystalline structure with centered vertices. Well-formed side surfaces can be observed in 18 nm particles.

The TEM studies showed that the studied liquid contains silver particles with an average diameter of 3.5 nm (see histogram, FIG. 11) and larger particles of several microns. The particles of both sizes possess a cubic crystalline structure with centered vertices and a lattice constant of a=0.408±0.002 nm. No structural defects, such as twinning, were observed for nanometer-sized particles.

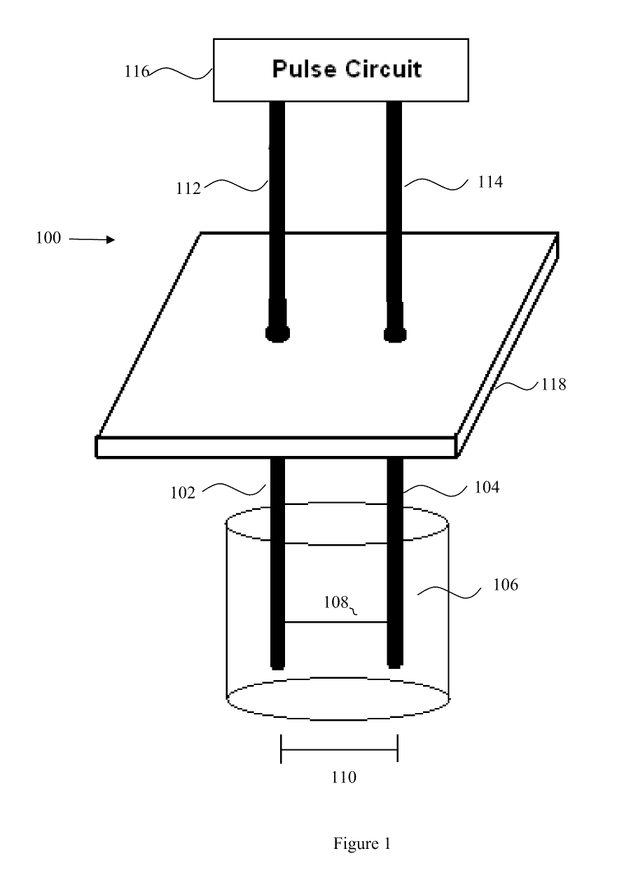

Referring to FIG. 1 and FIGS. 8A-C, a reactor, indicated generally at 100, for forming crystalline nanoparticles 802 comprises a dispersion medium 106, a first electrode 102 and second electrode 104 spaced from each other by a predetermined span 110. The electrodes 102, 104 are at least partially surrounded by or inserted into the dispersion medium 106 and are preferably made of copper, stainless steel, tungsten, or titanium. The reactor 100 further includes a filament 108 at least partially surrounded by or inserted into the dispersion medium 106 and being in contact with the first and second electrodes 102, 104. Preferably, the filament 108 is in the form of a wire and has a length at least as great as the span 110. Circuitry 116 is selectively coupled to the first and second electrodes by a first switch 206 for supplying a pulse of current at a preselected voltage. The apparatus may also include a first lead 112 and a second lead 114 connecting the electrodes 102, 104 to the circuitry 116. Either the electrodes or the leads may run through a firewall 118.

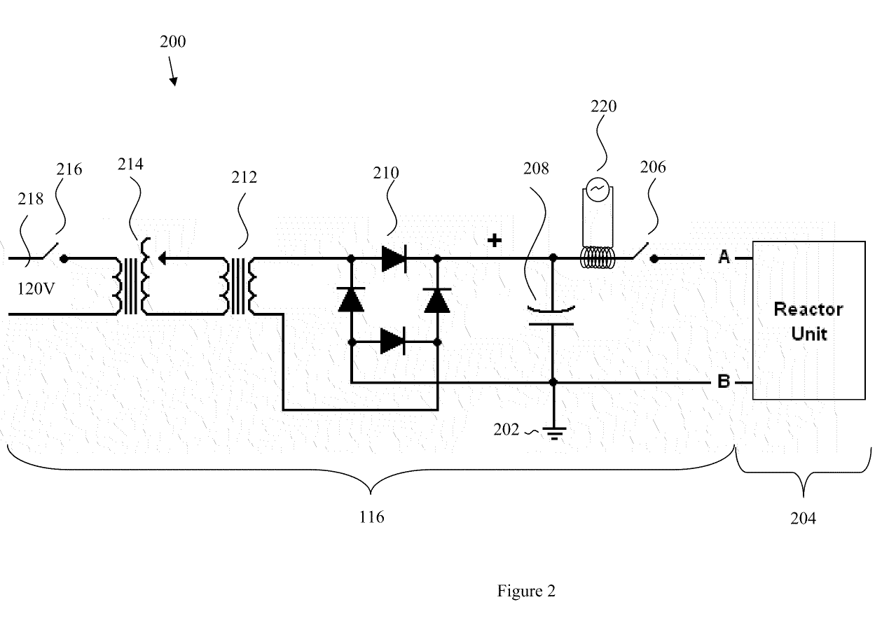

Referring to FIG. 2, an apparatus, indicated generally at 200, further includes circuitry 116 including a capacitor 208 connected across the first and second electrodes 102, 104. In a preferred embodiment, the preselected voltage is between approximately 1 kilovolts 30 kilovolts of direct current. More preferably, the preselected voltage is between approximately 8 kilovolts and approximately 20 kilovolts.

Upon the first switch 206 connecting the circuitry 116 to the electrodes 112, 114, a pulsed current passes from the first electrode 112 through the filament 108 to the second electrode 114. The voltage is preselected to be high enough to disintegrate the filament 108 into fragments including a plurality of crystalline nanoparticles 802 (see FIG. 8) but be low enough to avoid creating plasma from the filament 108.

The intensity of the first pulsed current may be equal to the square root of the product of the resistance (R), the induction (L), and the circuit capacity C, or (RLC)^{1/2}. In preferred embodiments, the first pulsed current is preferably between 1 kiloamphere and 50 kiloampheres.

The filament 108 may be made of chemically pure metals, metals with additives, alloys of metals, semiconductors, and even graphite. Preferably, the metals are gold, silver, or copper. More preferably, the filament 108 may be a wire having a diameter between approximately 0.05 mm to approximately 1.0 mm in diameter. Alternatively, the filament may be a graphite filament approximately 3-8 μm in diameter.

The dispersion medium 106 may comprise a wide variety of materials including water, gases, aerosols, gels, oils, organic liquids, polymerizing substances, dielectrics, and liquefied gases including but not limited to liquid nitrogen, helium, or argon. If water is used, pH values of approximately 6-8 are preferred.

The circuitry 116 may further comprise a capacitor charging circuit including a rectifier 210 coupled to and providing rectified power to a capacitor 208. Additionally, the capacitor charging circuit may include a high voltage transformer 212 coupled to and providing the preselected voltage to the rectifier 210. Moreover, the capacitor charging circuit may include a variable voltage transformer 214 coupled to and providing power to the high voltage transformer 212 and a second switch 216 connected to the variable voltage transformer 214. Also, the capacitor charging circuit may include an alternating power source 218, preferably a standard 120V alternating current wall receptacle, connected to and providing power to the second switch 216 as shown in FIG. 2.

Finally, the capacitor charging circuit may have an oscilloscope 220 connected between the capacitor 208 and the first electrode 112 so that the intensity and duration of the pulse can be monitored and adjusted. Also, a ground 202 can be included for safety.

Preferably, the nanoparticles 802 of the dispersed phase may vary in size from 2 to 8 nm, with a preferred average value of 3.5 nm. Moreover, the nanoparticles assume the shape of platelets with a typical thickness of 3-5 atoms and are nanocrystallites with an atomic crystal structure substantially identical to the input material. In preferred embodiments, the content of melted metal particles or metallic spheroids is less than 50%, and, more preferably, no more than 10 percent.

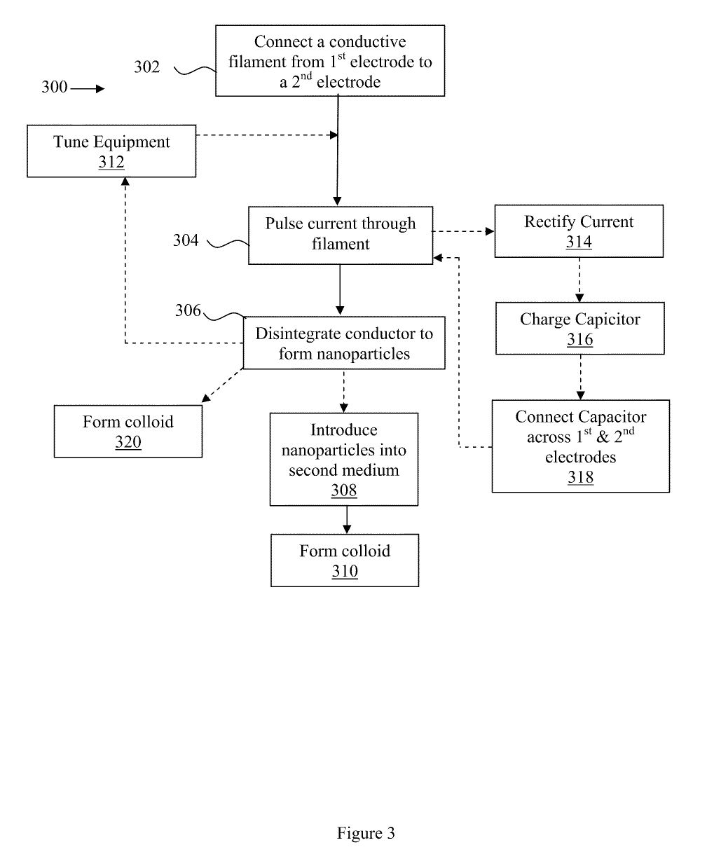

Referring to FIG. 3, a method, indicated generally at (300), for forming crystalline nanoparticles comprises connecting (302) a conductive filament from a first electrode in a dispersion medium to a second electrode in the dispersion medium and being spaced from the first electrode, such that the filament, in a predetermined span between the first and second electrodes, is in contact with the dispersion medium. The method further includes pulsing (304) a current at a predetermined voltage through the filament from the first electrode to the second electrode, and responsive to the step of pulsing, disintegrating (306) the filament into a plurality of fragments. The fragments include crystalline nanoparticles and the predetermined voltage of the pulsed current is selected to such that the step of disintegrating is not accompanied by the formation of plasma from the filament.

The step of disintegrating (306) the filament preferably lasts between approximately 1 microsecond and approximately 10 microseconds. Further, the step of pulsing (304) a current may comprise the substeps of charging (316) a capacitor of a preselected size at the predetermined voltage and thereafter connecting (318) the capacitor across the first and second electrodes to discharge the capacitor. Moreover, in preferred embodiments, the method may further include the step of rectifying (314) the current prior to charging (316) the capacitor.

In other embodiments of the invention, the method can include transforming current from a first voltage to a second voltage prior to rectifying (314) the supply of electrical current such that the second voltage is higher than the first voltage, and adjusting the supply of electrical current with a variable voltage transformer prior to transforming the current from a first voltage to a second voltage.

Additionally, the nanoparticles can be separated from the dispersion medium or be dispersed evenly throughout the dispersion medium by mixing. Preferred separation methods include evaporating, sublimating, electrostatically separating, and atomizer spray drying.

Upon initially setting up the equipment, the method may include tuning (312) the equipment to achieve the desired discharge characteristics of a minimized sonic and flash discharge as well as the clarity, color, and sedimentation. As described earlier, the sonic and flash discharge are characteristic of the explosive disintegration process and the flash can be seen in FIG. 5A. Tuning (312) can be done through optimizing the connections, filaments, voltage, reactor span, and capacitance. FIGS. 9A and 9B show the minimized shock and flash characteristic of the nonexplosive disintegration process.

In preferred embodiments, the crystalline nanoparticles and dispersion medium form (310) a colloid such as silver in vitamin solutions, gold in sterile distilled water, gold in physiological solutions, chromium-nickel in silicon oils, palladium in hydrocarbons, platinum in hydrocarbons, silver in an acetylsalicylic acid solutions, gold in acetylsalicylic acid solutions, silver in hydrocarbons, silver in alcohols, and silver in glycerin. More preferably, the colloid formed is nonionic and no visible sedimentation occurs.

The method may further comprise introducing (308) the nanoparticles into a second medium, preferentially a liquid or a gaseous one, or a polymerizing substance. Alternatively, the second medium may be water, vitamin solutions, hydrocarbons, acetylsalicylic acid, alcohols, dielectrics, physiological solutions, or glycerin. A physiological solution is any solution that can be safely injected into an animal or human body. At least a portion of the dispersion medium may be removed prior to placement in the other medium.

Table 3 shows several process conditions for sample colloids formed from the disintegration of silver, copper, and gold wires according to the invention. It can be seen from the data that no sedimentation or detonation occurs.

TABLE 3

| | Silver Colloid | Copper Colloid | Gold Colloid |
|---|---|---|---|
| Diameter, mm | 0.1 | 0.1 | 0.1 |
| Span, in | 1.5 | 1.8 | 2.0 |
| Voltage, kV | 11.0 | 14.0 | 10.0 |
| Capacitance, | 0.15 | 0.15 | 0.15 |
| μf | | | |
| Medium | water | water | water |
| pH | 5.5-6.5 | 5.5-6.5 | 5.5-6.5 |
| Result | colorless | colorless | slightly red |
| | colloid | colloid | colloid minimal |
| | minimal sound | minimal sound | sound and flash |
| | and flash | and flash | |

In the first experiment, the calculated amount of energy input to the wire was 30.34 Ws/mm³. In the copper and gold experiments, the calculated amount of energy input to the wire was 40.83 Ws/mm³, and 18.79 Ws/mm³, respectively.

In another embodiment of the invention, a plurality of crystalline nanoparticles comprises an electrically conducting material in the form of platelets having an average diameter between approximately 2-10 nanometers and an average thickness between approximately two and ten atoms. The electrically conducting material may be a metal, metal alloy, or semiconductor. Preferably, the metal includes silver, copper, gold, palladium, platinides, iron, chromium, nickel, tungsten, tantalum, molybdenum, titanium, metallurgical alloys, superalloys, and powder-metallurgy alloys.

Additionally, the nanoparticles have a homogenous structure substantially lacking chemical impurities and crystalline defects.

In another embodiment of the invention, a colloid comprises a dispersion medium and a dispersed phase comprising nonionic nanoparticles of an electrically conducting substance in the form of platelets. Each platelet has an average diameter of between approximately 2-10 nanometers and an average thickness between approximately 2-10 atomic layers.

A colloid according to the invention may be additionally dispersed in a gas, liquid, vapour, or a mixture thereof, or in a polymerizing substance or a polymer. Preferably, the electrically conducting substance is selected from a group containing chemically pure metals, metals intentionally contaminated with additives, alloys of metals, alloys of metals, semiconductors, or pseudoalloys. Preferably, the electrically conducting substance is a precious metal or its alloy.

Further, a colloid according to the invention may be selected from the group of silver in vitamin solutions, gold in sterile distilled water, gold in physiological solution, chromium-nickel compounds in silicon oils, palladium in aromatics, palladium in hydrocarbons, gold in an acetylsalicylic acid solution, silver in an acetylsalicylic acid solution, silver in hydrocarbons, and silver in alcohol.

In summary, a comparison of both the explosive and non-explosive production methods, demonstrates significant differences between the two techniques as well as the novel advantages of the present invention. To summarize:

1. a plasma channel does not appear around the wire;

2. in the absence of metal melting, the fragments do not assume structural modification, and they do not form spheroids, while the resultant fragments retain their initial, molecular structure identical to that of the virgin wire;

3. the geometry of the resultant nanofragments is flat (platelets or flakes), and the atomic structure is crystalline, FCC;

4. the active surface of this new product is also increased;

5. the degree of oxidation among the particles is minimal, since the temperature of the manufacturing process is radically reduced; and

6. no explosions occur in the reactor or during the manufacturing process.

While illustrated embodiments of the present invention have been described and illustrated in the appended drawings, the present invention is not limited thereto but only by the scope and spirit of the appended claims.

We claim:

1. Apparatus for forming crystalline nanoparticles comprising:
a dispersion medium;
a first electrode and a second electrode spaced from the first electrode by a predetermined span and being at least partially surrounded by the dispersion medium;
a filament at least partially surrounded by the dispersion medium, the filament being in contact with the first electrode and the second electrode; and
circuitry selectively coupled to the first and second electrodes by a first switch for supplying a pulse of current at a preselected voltage,
wherein, upon the first switch connecting said circuitry to the electrodes, a pulsed current passes from the first electrode through the filament to the second electrode, the voltage preselected to be high enough to disintegrate the filament into fragments including a plurality of crystalline nanoparticles but preselected to be low enough to avoid creating plasma from the filament.

2. The apparatus of claim 1, wherein the circuitry includes a capacitor connected across the first and second electrodes.

3. The apparatus of claim 2, wherein the circuitry further comprises a capacitor charging circuit including a rectifier coupled to and providing rectified power to the capacitor.

4. The apparatus of claim 3, wherein the capacitor charging circuit further comprises a high voltage transformer coupled to and supplying the preselected voltage to the rectifier.

5. The apparatus of claim 1, wherein the pulsed current is preselected from the range of between approximately 1 kA to approximately 50 kA.

6. The apparatus of claim 1, wherein the preselected voltage is between approximately 1 kilovolt and approximately 30 kilovolts.

7. The apparatus of claim 1, wherein the preselected voltage is 11 kilovolts direct current, the filament is a silver wire with a 0.1 mm diameter, the span is 1.5 inches, the medium is distilled water having a pH of between approximately 6.0 and approximately 8.0, and the circuitry includes a capacitor having a capacitance of approximately 0.15 microfarads and being connected across the first and second electrodes.

8. The apparatus of claim 1, wherein the preselected voltage is 14 kilovolts direct current, the filament is a copper wire with a 0.1 mm diameter, the span is 1.8 inches, the medium is distilled water having a pH of between approximately 6.0 and approximately 8.0, and the circuitry includes a capacitor having a capacitance of approximately 0.15 microfarads and being connected across the first and second electrodes.

9. The apparatus of claim 1, wherein the preselected voltage is 10 kilovolts direct current, the filament is a gold wire with a 0.1 mm diameter, the span is 2.0 inches, the medium is distilled water having a pH of between approximately 6.0 and approximately 8.0, and the circuitry includes a capacitor having a capacitance of approximately 0.15 microfarads and being connected across the first and second electrodes.

10. The apparatus of claim 6, wherein the preselected voltage is between approximately 8 kilovolts and approximately 20 kilovolts.

11. The apparatus of claim 1, wherein the filament is selected from the group consisting of chemically pure metals, metals with additives, alloys of metals, graphite, and semiconductors.

12. The apparatus of claim 11, wherein the metal is selected from the group consisting of gold, silver, and copper.

13. The apparatus of claim 1, wherein the dispersion medium comprises a material selected from the group consisting of water, gases, liquefied gases, aerosols, gels, oils, and organic liquids.

14. The apparatus of claim 13, wherein the dispersion medium is water having a pH between approximately 6.0 and approximately 8.0.

15. The apparatus of claim 1, wherein the first electrode and second electrode comprise a metal selected from the group consisting of stainless steel, copper, tungsten, and titanium.

16. The apparatus of claim 1, wherein the filament is a wire.

17. The apparatus of claim 16, wherein the wire has a diameter of between approximately 0.05 mm and approximately 1.0 mm.

18. The apparatus of claim 1, wherein the energy applied to the filament by pulsed current is between approximately 15 watt seconds/mm³ and approximately 100 watt seconds/mm³.

19. A method for forming crystalline nanoparticles comprising the steps of:
connecting a conductive filament from a first electrode in a dispersion medium to a second electrode in the dispersion medium and spaced from the first electrode, such that the filament, in a predetermined span between the first and second electrodes, is in contact with the dispersion medium;
pulsing a current at a predetermined voltage through the filament from the first electrode to the second electrode; and
responsive to said step of pulsing, disintegrating the filament into a plurality of fragments, the fragments including crystalline nanoparticles, the predetermined voltage of the pulsed current selected that said step of disintegrating is not accompanied by the formation of plasma from the filament.

20. The method of claim 19, wherein the crystalline nanoparticles and dispersion medium form a colloid.

21. The method of claim 20, wherein the colloid is selected from the group consisting of silver in vitamin solutions, gold in sterile distilled water, gold in physiological solutions, chromium-nickel in silicon oils, palladium in hydrocarbons, platinum in hydrocarbons, silver in an acetylsalicylic acid solutions, gold in acetylsalicylic acid solutions, silver in hydrocarbons, silver in alcohols, and silver in glycerin.

22. The method of claim 20, wherein the colloid formed is nonionic.

23. The method of claim 19, wherein no visible sedimentation occurs.

24. The method of claim 19, further comprising the step of introducing the nanoparticles into a second medium selected from the group of a liquid, a gas, and a polymerizing substance.

25. The method of claim 19, wherein the second medium is selected from the group consisting of water, vitamin solutions, hydrocarbons, acetylsalicylic acid, alcohols, dielectrics, physiological solutions, and glycerin.

26. The method of claim 19, wherein the filament has a disintegration time between approximately 1 microsecond to approximately 10 microseconds.

27. The method of claim 19, wherein said step of pulsing a current includes the substeps of:
charging a capacitor of a preselected size at the predetermined voltage; and
thereafter connecting the capacitor across the first and second electrodes to discharge the capacitor.

28. The method of claim 19, further comprising the step of rectifying the current prior to charging the capacitor.

29. The method of claim 19, further comprising the step of tuning the apparatus by optimizing a parameter selected from the group of connections, filaments, voltage, reactor span, and capacitance.

30. Crystalline nanoparticles comprising:
an electrically conducting material in the form of platelets having an average diameter between approximately 2 and approximately 10 nanometers and an average thickness between approximately 1 and approximately 10 atomic layers.

31. The nanoparticles of claim 30, wherein the electrically conducting material is selected from the group consisting of metals, metal alloys, superalloys, powder metallurgy alloys, and semiconductors.

32. The nanoparticles of claim 31, wherein the electrically conducting material includes a metal selected from the group consisting of silver, copper, gold, palladium, platinides, iron, chromium, nickel, tungsten, tantalum, molybdenum, titanium, metallurgical alloys, superalloys, and powder-metallurgy alloys.

33. The nanoparticles of claim 30, wherein the nanoparticles have a homogenous structure substantially lacking chemical impurities or crystalline defects.

34. The nanoparticles of claim 30, where in the nanoparticles are distributed as a dispersed phase in a dispersion medium to form a colloid.

35. The nanoparticles of claim 30, wherein approximately 80% of the nanocrystallites possess a diameter of about 35 and a thickness of about 10 angstroms

36. A colloid comprising:
a dispersion medium; and
a dispersed phase comprising nonionic nanoparticles of an electrically conducting substance in the form of platelets and having an average diameter between approximately 2 and approximately 10 nanometers and an average thickness between approximately 2 and approximately 10 atomic layers.

37. The colloid of claim 36, wherein the electrically conducting substance is selected from the group of chemically pure metals, metals intentionally contaminated with additives, alloys of metals, alloys of metals, semiconductors, and pseudoalloys.

38. The colloid of claim 37, wherein the electrically conducting substance is a precious metal or its alloy.

39. The colloid of claim 36, wherein the dispersion medium and dispersed phase are selected from the group of silver in vitamin solutions, gold in sterile distilled water, gold in physiological solution, chromium-nickel compounds in silicon oils, palladium in aromatics, palladium in hydrocarbons, gold in an acetylsalicylic acid solution, silver in an acetylsalicylic acid solution, silver in hydrocarbons, and silver in alcohol.
